(19) United States
(12) Patent Application Publication
(10) Pub. No.: US 2026/0168223 A1
(43) Pub. Date: Jun. 18, 2026

(54) ILLUMINATED POP-UP DRAIN

(71) Applicant: Delta Faucet Company, Indianapolis, IN (US)

(72) Inventor: David Lee, Westfield, IN (US)

(21) Appl. No.: 19/418,147

(22) Filed: Dec. 12, 2025

Related U.S. Application Data
(60) Provisional application No. 63/733,733, filed on Dec. 13, 2024.

(51) Int. Cl. E03C 1/23; F21V 33/00

(52) U.S. Cl. CPC E03C 1/2306; F21V 33/004

(57) ABSTRACT

An illuminated drain assembly for a sink basin having a drain opening. The illuminated drain assembly includes a tube having a top end fluidly coupled to the drain opening of the sink basin. A drain stopper seals the drain opening of the sink basin. A light-emitting device is mounted to the drain stopper. A first electrical conductor is coiled around an outer surface of the tube. The first electrical conductor has two opposite ends electrically connected to a voltage source. A second electrical conductor is coiled around an inner surface of the tube at a location such that an electrical current through the first electrical conductor induces an electrical current through the second electrical conductor. The second electrical conductor has two opposite ends electrically connected to the light-emitting device.

### CROSS-REFERENCE TO RELATED APPLICATION

The present application claims priority to U.S. Provisional Patent Application Ser. No. 63/733,733, filed Dec. 13, 2024, the disclosure of which is expressly incorporated herein by reference.

### BACKGROUND AND SUMMARY OF THE INVENTION

The present invention relates generally to a night light for illuminating an area around a sink.

Current examples of the application of lighting in a lavatory area focused around the sink include lighting of the stream of water leaving the faucet, lighting a handle, lighting the rear of the faucet, etc. The primary constraint is that these executions drive a need for full customization for every faucet that is produced, to include wiring for the light in an inconspicuous location. Inclusion of a universal light base reduces the variety with higher volumes, but may be considered a fundamental limitation to industrial design flexibility of the faucet.

The illustrative night light of the present disclosure may be applied universally across faucets that are installed in sinks with pop-up drains (e.g., push-pop drains) cooperating with a variety of tail pieces. The disclosure may enable the potential features of a night light integrated into a faucet or sink without having to fully customize an additional component to be assembled beneath the faucet, such as a light-emitting diode (LED) base to be placed between the faucet and the counter. The illustrative nightlight of the present disclosure also has the potential to greatly reduce the risk of damage during installation from cut wires or shorted wires on sinks or countertops.

The illustrative device may be supported and independent of the faucet, and can replace an existing pop-up drain without any additional cords or cables coupled to the faucet. Electrical power can be transmitted wirelessly from around the exterior of the drain tail piece through to the pop-up drain on the interior of the drain tail piece. The pop-up drain has a light (e.g., an LED) illuminating, for example, either underneath the drain cap and outwards in the sink basin, or upwards towards the user and the out of the sink basin.

The LED may be electrically connected to an inductive coil that is wrapped around the pop-up drain plug. Illustratively, a pop-up drain is slidably received in the tail piece. The tail piece is illustratively made of a non-electrically conductive and non-metallic material.

An inductive coil is illustratively placed around the tail piece in a location that at least partially surrounds the inductive coil of the pop-up drain plug. Illustratively, the inductive coil for the tail piece is connected to a power supply.

As the power supply is activated (for example, via a switch, or the power may always be provided), the tail piece inductive coil generates an electro-magnetic field. That magnetic field induces a current in the pop-up drain plug inductive coil through the non-metallic and non-electrically conductive tail piece, and the LED is lit or illuminated from the induced current.

A thermistor may be coupled to the drain plug (for example, via a decorative drain cap) to measure the temperature of water in the sink when the drain is closed or open. An output of the thermistor may be received by an electronic processor that controls the voltage applied to the LED. The processor can adjust the voltage applied to the LED based on the water temperature measured by the thermistor so that the brightness of the light indicates the measured water temperature. Alternatively, or in addition thereto, the LED may be capable of emitting different colors of light, and the processor can control the color of light emitted by the LED based on the measured water temperature.

Lastly, with the power and electrical components disposed beneath the deck, a switch or human presence sensor may be disposed remote from the drain, such as near the cabinet door below the deck. This location may enable the presence detection to be more customized than with a sensor fixed on the faucet.

According to an illustrative embodiment of the present disclosure, an illuminated drain assembly is provided for a sink basin having a drain hole. The illuminated drain assembly includes a tube having a top end fluidly coupled to the drain hole of the sink basin. A drain stopper is configured to seal the drain hole of the sink basin. A light-emitting device is mounted to the drain stopper. A first electrical conductor is coiled around an outer surface of the tube. The first electrical conductor has two opposite ends electrically connected to a voltage source. A second electrical conductor is coiled around an inner surface of the tube at a location such that an electrical current through the first electrical conductor induces an electrical current through the second electrical conductor. The second electrical conductor has two opposite ends electrically connected to the light-emitting device.

According to another illustrative embodiment of the present disclosure, an illuminated drain assembly is provided for a sink basin having a drain hole. The illuminated drain assembly includes a tube having a top end fluidly coupled to the drain hole of the sink basin. The tube has a cylindrical side wall defining a through-hole along its length. A drain stopper is configured to seal the drain hole of the sink basin. A light-emitting device is mounted to the drain stopper. An electrical conductor extends through the side wall of the tube and the through-hole of the tube. A grommet is supported within the through-hole and receives the electrical conductor. The electrical conductor has a first end electrically connected to the light-emitting device, and a second end electrically connected to a voltage source.

According to yet another illustrative embodiment of the present disclosure, an illuminated drain assembly is provided for a sink basin having a drain hole. The illuminated drain assembly includes a tube having a top end fluidly coupled to the drain hole of the sink basin. A drain stopper is configured to seal the drain hole of the sink basin. A light-emitting device is associated with the drain stopper. An electrical conductor applies a voltage to the light-emitting diode when the electrical conductor carries an electrical current. A switch is connected in series with the electrical conductor. A presence detector senses a presence of a human being in a vicinity of the sink basin. The presence detector causes the switch to be closed such that the electrical conductor is able to carry electrical current when the presence of the human being in the vicinity of the sink basin is sensed. The presence detector causes the switch to be open such that the electrical conductor is unable to carry electrical current when the presence of the human being in the vicinity of the sink basin is not sensed.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an inductive pop-up drain nightlight arrangement in accordance with one illustrative embodiment of the present disclosure;

FIG. 2 is an exploded perspective view of the pop-up drain nightlight arrangement illustrated in FIG. 1;

FIG. 3 is an exploded perspective view of an illustrative embodiment of an outer pipe assembly and primary coil utilized in the embodiment illustrated in FIG. 1;

FIG. 4 is a cross-sectional view taken along section line 4-4 in FIG. 3;

FIG. 5 is a cross-sectional view along section line 5-5 in FIG. 1;

FIG. 6a is a cross-sectional view of another illustrative embodiment of an inductive pop-up drain nightlight arrangement of the present disclosure;

FIG. 6b is a side view of yet another illustrative embodiment of an inductive pop-up drain nightlight arrangement of the present disclosure;

FIG. 6c is a side view of a further illustrative embodiment of an inductive pop-up drain nightlight arrangement of the present disclosure;

FIG. 6d is a cross-sectional view of still another illustrative embodiment of an inductive pop-up drain nightlight arrangement of the present disclosure;

FIG. 7 is a schematic diagram of yet another illustrative embodiment of an inductive pop-up drain nightlight arrangement of the present disclosure;

FIG. 8 is a longitudinal cross-sectional view of a further illustrative embodiment of an inductive pop-up drain nightlight arrangement of the present disclosure;

FIG. 9 is a longitudinal cross-sectional view of another illustrative embodiment of an inductive pop-up drain nightlight arrangement of the present disclosure; and

FIG. 10 is a longitudinal cross-sectional view of yet another illustrative embodiment of an inductive pop-up drain nightlight arrangement of the present disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

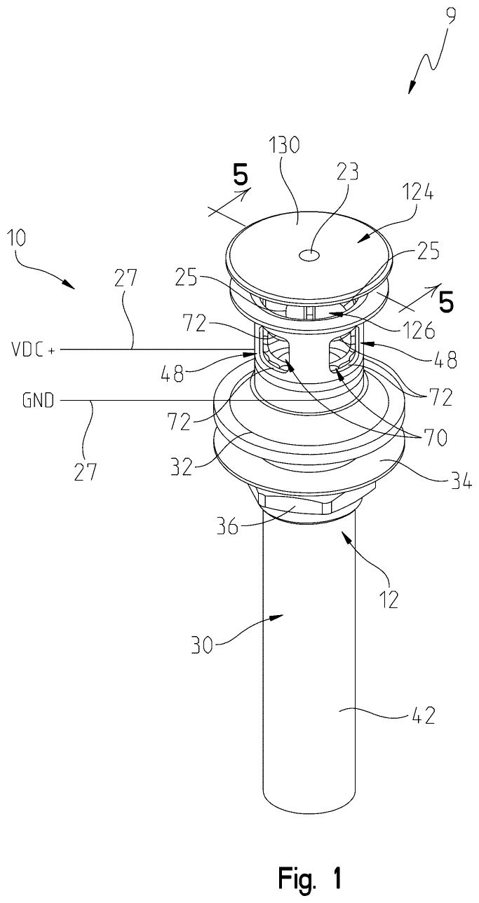

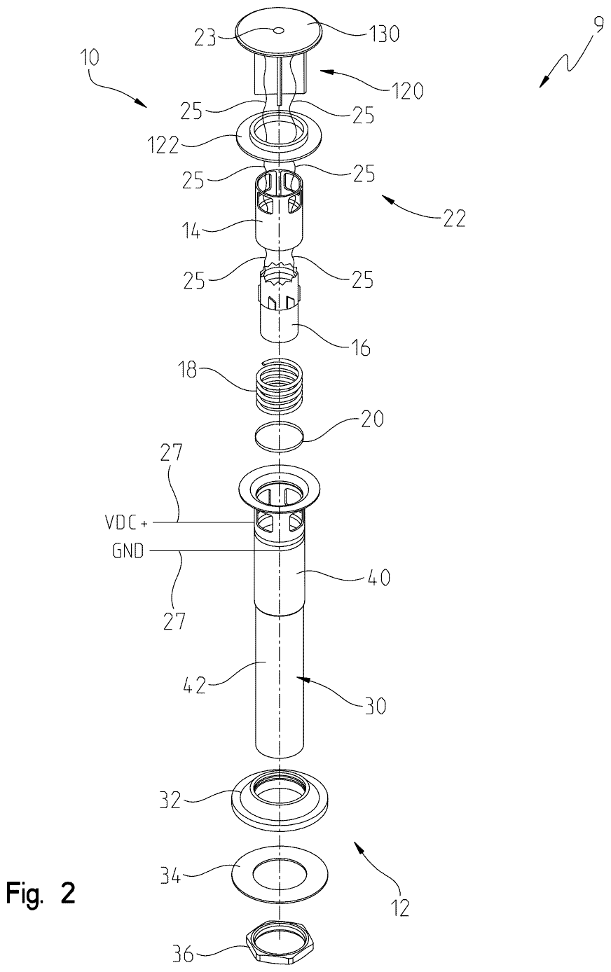

Referring first to FIGS. 1 and 2, numeral 9 generally indicates an inductive pop-up drain nightlight arrangement or device illustrative of an embodiment of the present disclosure. In the illustrative embodiment, inductive pop-up drain nightlight arrangement 9 includes a pop-up (illustratively, a push-pop) drain assembly 10, a light such as a light-emitting diode (LED) 23, and electrical conductors 25 and 27. Pop-up drain assembly 10 illustratively includes an outer pipe assembly (or tail pipe assembly), generally indicated by numeral 12, a first or receiving member 14, a second or actuating member 16, a spring 18, a washer 20 and a stopper assembly 22.

Illustrative stopper assembly 22 includes a stopper member 120 and a gasket 122. Stopper member 120 includes a head portion 124 and a body portion 126. In the depicted embodiment, head portion 124 includes an arcuate top surface 130. As is known, stopper assembly 22 is slidably moveable relative to the outer pipe assembly 12 between an open position and a closed (or sealed) position.

The light-emitting diode (LED) 23 is illustratively mounted at a center of head portion 124 of stopper member 120. LED 23 has two terminals (not shown) which are each electrically connected to a respective end of the electrical conductor (e.g., a wire) 25 that extends through head portion 124. Wire 25 may be covered by a layer of electoral insulation, and may be coiled around an interior surface of receiving member 14 and/or an interior surface of actuating member 16. The other electrical conductor (e.g., a wire) 27 is wrapped around an outer pipe 30 of outer pipe assembly 12, near its top end. One end of wire 27 is connected to a source of direct current (DC) voltage, which may be approximately between 3 Volts DC and 12 Volts DC. The other end of wire 27 is connected to electrical ground. The source of DC voltage may be a conventional AC/DC adapter which is plugged into a conventional alternating current (AC) voltage wall outlet or receptacle that supplies 120 Volts AC.

Current through wire 27 may create an electro-magnetic field that induces a current through wire 25 that powers LED 23. Thus, wire 27 may be referred to as a “primary coil” and wire 25 may be referred to as a “secondary coil”.

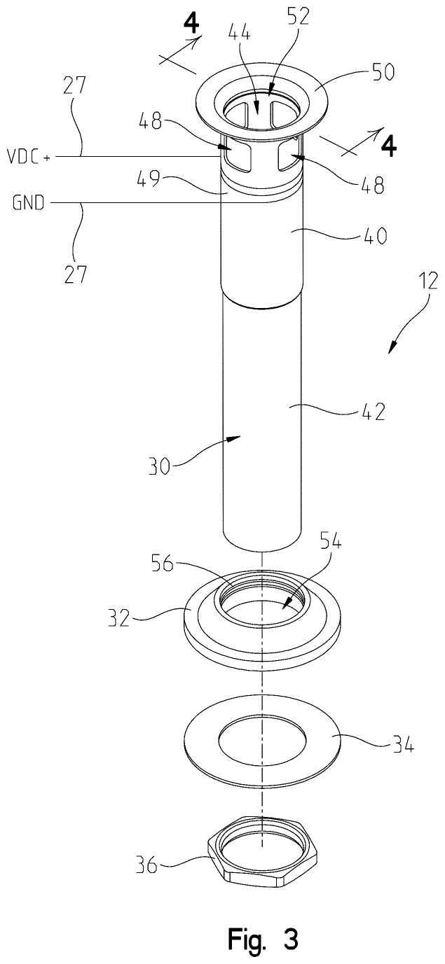

FIG. 3 is an exploded perspective view of outer pipe assembly 12. In the illustrative embodiment, outer pipe assembly 12 includes outer pipe 30, a gasket 32, a washer 34 and a mounting nut 36.

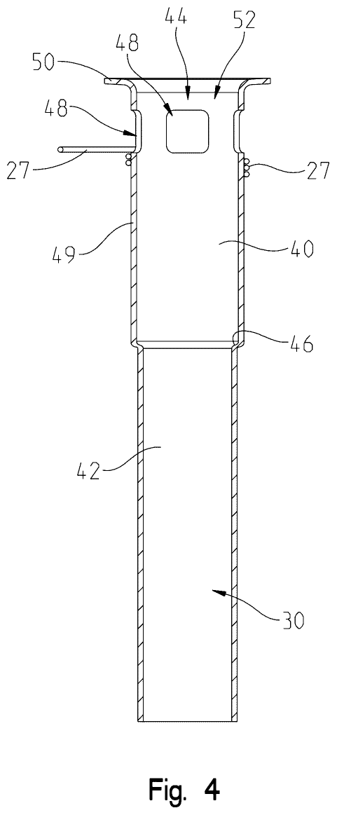

FIG. 4 is a cross-sectional view of outer pipe 30 taken along section line 4-4 of FIG. 3. With reference to both FIGS. 3 and 4, outer pipe 30 may be formed from any suitable non-metallic and non-electrically conductive material and includes a first portion 40 and a second portion 42. First portion 40 may be attached to second portion 42 in any suitable fashion. For example, in certain illustrative embodiments, the portions 40 and 42 may be integrally formed from a single piece of material. In other embodiments, the portions 40 and 42 may be formed separately and affixed to each other in a suitable fashion, such as through the utilization of some type of known component, such as a sleeve.

With reference still to FIGS. 3 and 4, in the illustrative embodiment, the first and second portions 40, 42 each have substantially cylindrical shapes. The cylindrical shapes of portions 40, 42 define a central bore or passageway, generally indicated by numeral 44 that extends through the outer pipe 30. In the depicted embodiment, first portion 40 has a larger diameter than second portion 42, and the interconnection of the portions 40, 42 defines a land, generally indicated by numeral 46.

Referring further to FIGS. 3 and 4, first portion 40 includes a plurality of apertures 48 and a flange 50. In the illustrative embodiment, first portion 40 includes four apertures 48 each having a rectangular shape. However, the number and shapes of apertures 48 may vary. The apertures 48 are positioned proximate the flange 50 and extend through the cylindrical side wall 49 of the first portion 40. Apertures 48 may be formed within first portion 40 in any suitable manner.

In the illustrative embodiment, flange 50 encompasses an edge of first portion 40. Flange 50 may be integrally formed in first portion 40 or may be a separate component connected to first portion 40 in a known manner. The outer diameter of flange 50 is larger than the diameter of side wall 49, and thus, flange 50 extends beyond the lateral boundaries defined by side wall 49. As depicted in FIGS. 3 and 4, flange 50 defines an opening 52 at an end of first portion 40, and opening 52 may function as a drain hole. In the closed or sealed position, stopper member 120 and gasket 122 of stopper assembly 22 seals opening 52 from water flow. When raised to the open position, stopper member 120 and gasket 122 of stopper assembly 22 allows water flow through opening 52.

The receiving member 14 illustratively includes a plurality of apertures, each indicated by numeral 70. Apertures 70 illustratively have shapes similar to that of apertures 48 in outer pipe 30. In addition, the apertures 70 are illustratively spaced about receiving member 14 at positions complementary to the positions of the apertures 48 in outer pipe 30.

A plurality of protrusions, each indicated by numeral 72, may extend outwardly from an outer surface of the receiving member 14. In the illustrative embodiment, a pair of protrusions 72 are positioned proximate each aperture 70, with one protrusion 72 of the pair located above the aperture 70, and the other protrusion 72 of the pair located below the aperture 70.

With reference again to FIG. 3, gasket 32 may be formed from any suitable material such as rubber or soft plastic, for example. In the illustrative embodiment, gasket 32 includes an opening indicated by numeral 54. Opening 54 may be sized and configured to receive the first portion 40 of outer pipe 30. Opening 54 may include a plurality of annular ribs 56 configured to retain second portion 42 within gasket 32 after second portion 42 has been inserted into opening 54. In embodiments, ribs 56 may be replaced with any suitable configuration capable of achieving similar goals.

Referring still to FIG. 3, washer 34 may be formed from any suitable material. In the illustrative embodiment, washer 34 is sized and configured to receive first portion 40 of outer tube 30. Nut 36 may also be formed from any suitable material. In addition, nut 36 may engage first portion 40 in a suitable manner. For example, the outer surface of first portion 40 may include threads (not shown) configured to mate with threads (not shown) formed on the inner surface of nut 36 in a known manner. In one illustrative embodiment, washer 34 and nut 36 may be received on outer pipe 30 for securing the nightlight arrangement 9 to a sink basin (not shown).

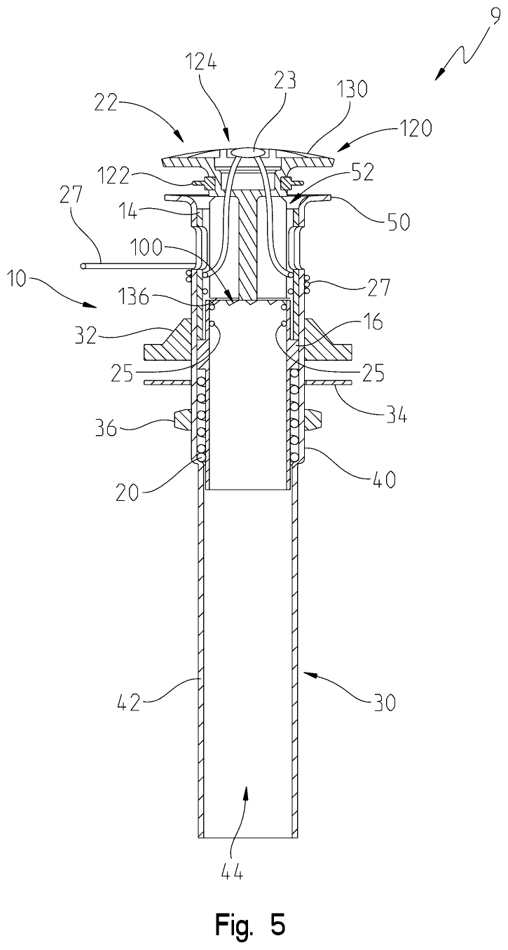

As shown in FIG. 5, wire 25 is illustratively coiled around the interior surfaces of both receiving member 14 and actuating member 16. FIG. 5 illustrates that the head portion 124, including arcuate surface 130, of stopper assembly 22 has a diameter greater than that of flange 50. Similarly, gasket 122 has an outer diameter greater than the inner diameter of outer pipe 30.

In the illustrative embodiment, stopper assembly 22 is fully inserted when lower surfaces 136 contact camming surfaces 100 of actuating member 16. Once the stopper assembly 22 has been inserted into receiving member 14, the assembly of drain assembly 10 is complete.

Other details of drain assembly 10 may be substantially similar to those disclosed in U.S. Patent Application Publication No. 2008/0178382, the disclosure of which is hereby incorporated by reference herein.

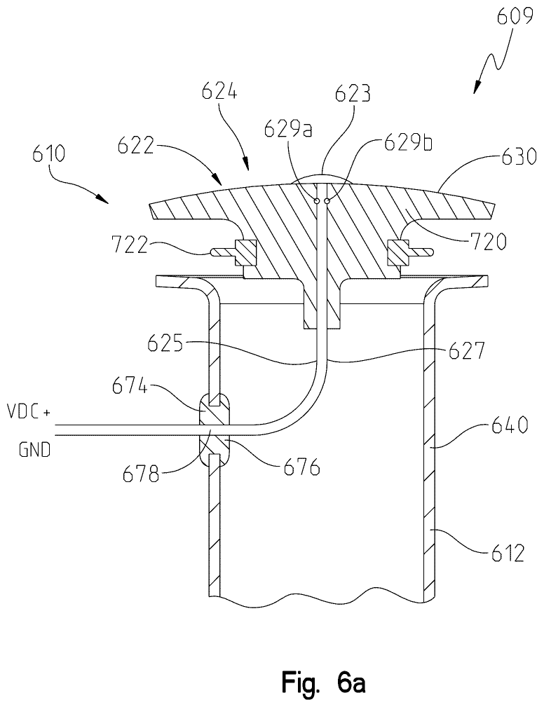

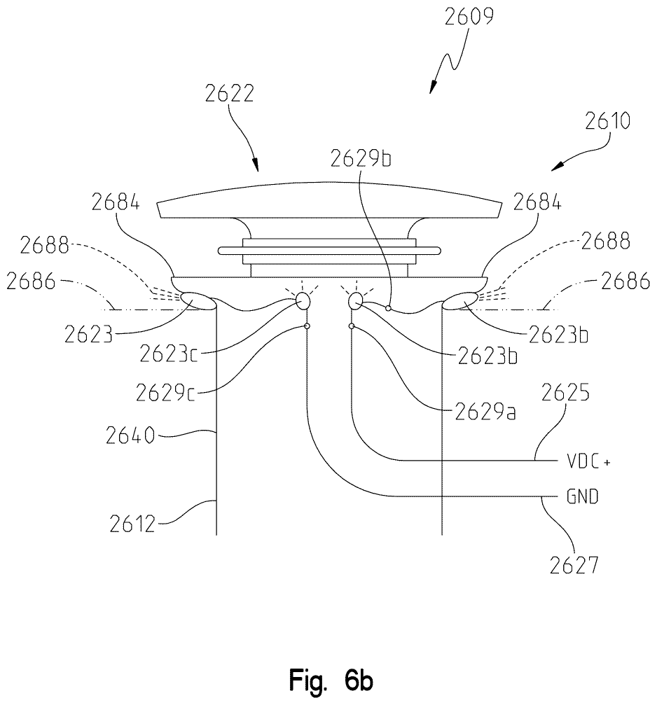

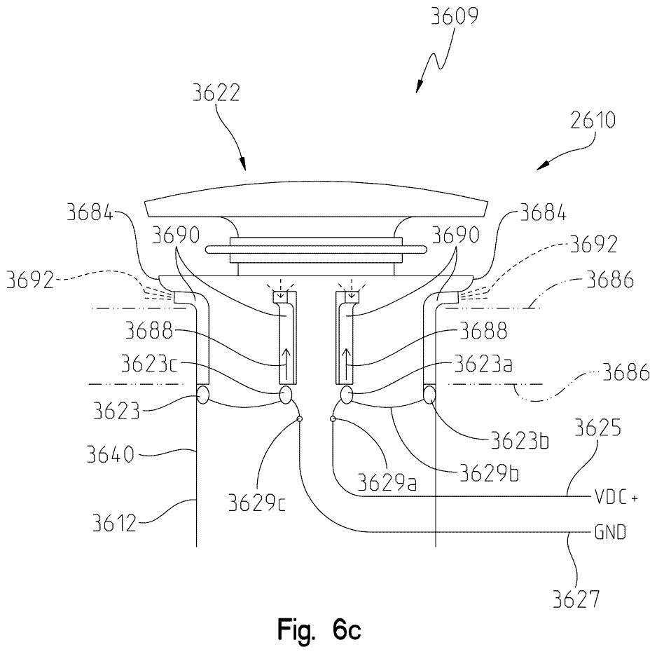

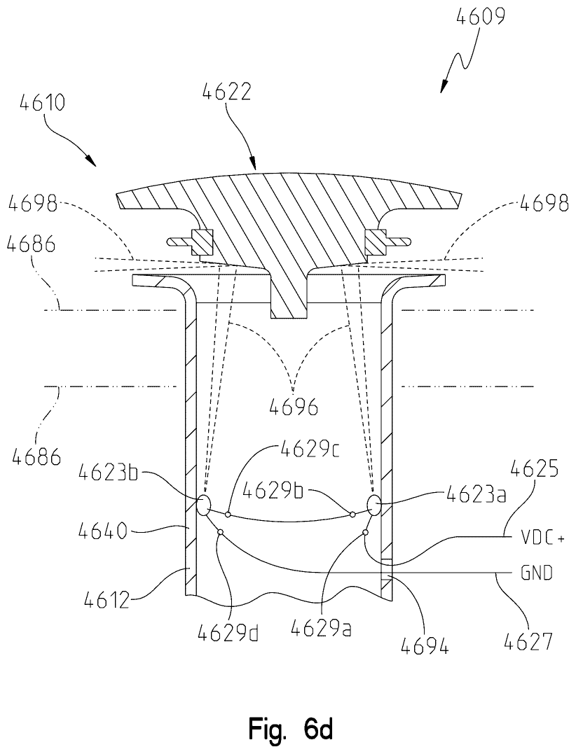

In another illustrative embodiment, a hardwired pop-up drain nightlight arrangement includes an electrical power cable extending through a sealed hole of a traditional pop-up drain cover, converting a traditional pop-up/lift rod set to a push-pop/LED drain cover. FIG. 6a is a simplified illustration of an illustrative pop-up drain nightlight arrangement 609, including a pop-up drain assembly 610, light-emitting diode (LED) 623, and electrical conductors 625, 627. Pop-up drain assembly 610 includes a first portion 640 of an outer pipe assembly 612 and a stopper assembly 622.

Illustrative stopper assembly 622 includes a stopper member 720 and a gasket 722. Stopper member 720 illustratively includes a head portion 624 having an arcuate top surface 630.

The light-emitting diode (LED) 623 is illustratively mounted at a center of head portion 624 of stopper member 720. LED 623 has two terminals 629a-b which are electrically connected to ends of the respective electrical conductors (e.g., wires) 625, 627 that extend through head portion 624. Wires 625, 627 may each be covered by a layer of electoral insulation.

First portion 640 of outer pipe assembly 612 may include a through-hole 674 having a seal 676 (e. g, a grommet) received therein. Grommet 676 includes a through-hole 678 through which wires 625, 627 extend. The ends of wires 625, 627 outside of outer pipe assembly 612 are electrically connected to VDC+ and electrical ground, respectively. Through-hole 678 may be similar to a through-hole through which a pivot rod extends in a pop-up drain. In fact, through-hole 678 may actually be the through-hole through which a pivot rod normally extends in the case where a conventional pop-up drain is converted to a push-pop drain nightlight arrangement 609 of the present invention.

In yet another illustrative embodiment of a hardwired pop-up drain nightlight arrangement 2609 (FIG. 6b), an electrical power cable extends up the outer surface of the first portion 2640 of an outer pipe assembly 2612. A pop-up drain assembly 2610 further includes a stopper assembly 2622, a plurality of light-emitting diodes (LEDs) 2623, and electrical conductors (e.g., wires) 2625, 2627.

The light-emitting diodes (LEDs) 2623 are illustratively mounted evenly-spaced under an annular lip 2684 at the top end of outer pipe assembly 2612, and above the level of a sink basin 2686. LEDs 2623 are connected in series. That is, VDC+ is connected to wire 2625, which in turn is connected to one terminal 2629a of an LED 2623a. The other terminal 2629b of LED 2623a is connected to a terminal of an adjacent LED 2623b and so on until all of the LEDs 2623 are connected in series. A terminal 2629c of the final LED 2623c is connected to electrical ground by wire 2627. Wires 2625, 2627, as well as the wires connecting the other LEDs 2623, may each be covered by a layer of electoral insulation. In the embodiment of FIG. 6b, all LEDs 2623 and electrical conductors are disposed outside of outer pipe assembly 2612.

During use, LEDs 2623 emit light outwardly, as indicated at 2688. The light may reflect off of the sink basin 2686 and off of the lip 2684 to thereby illuminate the sink basin 2686.

In a further illustrative embodiment of a hardwired pop-up drain nightlight arrangement 3609 (FIG. 6c), an electrical power cable is disposed on the outer surface of the first portion 3640 of an outer pipe assembly 3612. A pop-up drain assembly 3610 further includes a stopper assembly 3622, a plurality of light-emitting diodes (LEDs) 3623, electrical conductors (e.g., wires) 3625, 3627, and a plurality of light pipes 3690.

The light-emitting diodes (LEDs) 3623 are illustratively mounted evenly-spaced around a circumference of outer pipe assembly 3612, and below the level of a sink basin 3686. LEDs 3623 are connected in series. That is, VDC+ is connected to wire 3625, which in turn is connected to one terminal 3629a of an LED 3623a. The other terminal 3629b of LED 3623a is connected to a terminal of an adjacent LED 3623b and so on until all of the LEDs 3623 are connected in series. A terminal 3629c of the final LED 3623c is connected to electrical ground by wire 3627. Wires 3625, 3627, as well as the wires connecting the other LEDs 3623, may each be covered by a layer of electoral insulation. In the embodiment of FIG. 6c, all LEDs 3623 and electrical conductors are disposed outside of outer pipe assembly 3612.

Light pipes 3690 are illustratively mounted evenly-spaced around a circumference of outer pipe assembly 3612, and approximately at the level of the sink basin 3686. A lower end of each light pipe 3690 is disposed above and closely adjacent to a respective one of LEDs 3623, below sink basin 3686. An upper end of each light pipe 3690 is disposed below an annular lip 3684 at the top end of outer pipe assembly 3612, and above the level of the sink basin 3686.

During use, LEDs 3623 emit light upwardly and into light pipes 3690, as indicated at 3688. The light pipes 3690 carry the light to their upper ends, where the light is emitted outwardly, as indicated at 3692. The light may reflect off of the sink basin 3686 and off of the lip 3684 to thereby illuminate the sink basin 3686. Although the use of light pipes is disclosed it is within the scope of the invention to instead use tails/seals acting as light pipes.

In still another illustrative embodiment of a hardwired pop-up drain nightlight arrangement 4609 (FIG. 6d), an electrical power cable extends through a through-hole 4694 in the first portion 4640 of an outer pipe assembly 4612. A pop-up drain assembly 4610 further includes a stopper assembly 4622, light-emitting diodes (LEDs) 4623a-b, and electrical conductors (e.g., wires) 4625, 4627. The through-hole 4694 may be filled with epoxy after wires 4625, 4627 have be fed therethrough in order to prevent leaks from the pipe assembly 4612 and to hold wires 4625, 4627 in place. The LEDs and/or light pipes of this and other embodiments may be held in place with such epoxy.

The light-emitting diodes (LEDs) 4623a-b are illustratively mounted diametrically opposed to each other on opposite sides of the inner surface of the first portion 4640 of the outer pipe assembly 4612, and below the level of a sink basin 4686. LEDs 4623a-b are connected in series. That is, VDC+ is connected to wire 4625, which in turn is connected to one terminal 4629a of the LED 4623a. The other terminal 4629b of LED 4623a is connected to one terminal 4629c of adjacent LED 4623b. The other terminal 4629d of LED 4623b is connected to electrical ground by wire 4627. Wires 4625, 4627, as well as the wire connecting the LEDs 4623a-b, may each be covered by a layer of electoral insulation.

During use, LEDs 4623a-b emit light upwardly, as indicated at 4696. The light may reflect off of the bottom surface of the stopper assembly 4622 in lateral directions as indicated at 4698 to thereby illuminate the sink basin 4686.

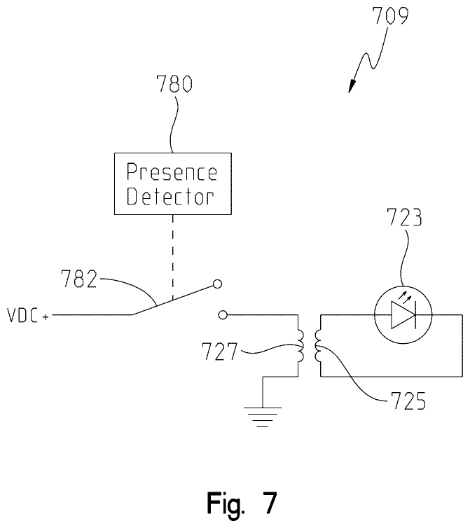

FIG. 7 is a schematic diagram of yet another illustrative embodiment of an inductive pop-up drain nightlight arrangement 709 of the present disclosure, including a presence detector 780, a switch 782, a primary coil 727, a secondary coil 725 and an LED 723. LED 723 may be disposed on a sink drain cap, or at any other location that enables LED 723 to illuminate the space around the sink, basin, faucet and/or valve handles. Presence detector 780 may be mounted on a cabinet door in front of the sink, for example, and may detect the presence of a person in front of the sink. Presence detector 780 may use any conventional technology, such as infrared, ultrasonic waves, or radar to detect movement and presence of a person near the sink.

During use, presence detector 780 may detect a person standing in front of the sink where he may need some light. In response to detecting the person, presence detector 780 may close switch 782, thereby applying voltage VDC+ across primary coil 727. The resulting current through primary coil 727 creates an electro-magnetic field that induces a current through secondary coil 725 and LED 723, thereby causing LED 723 to emit light around the sink.

Although switch 782 is shown as being electrically connected in series with primary coil 727, it is alternatively possible for the switch 782 to be electrically connected in series with the secondary coil 725. The presence detector 780 can control the switch 782 regardless of whether it is connected in series with the primary coil 727 or the secondary coil 725.

The primary coil 725 has been described herein as being electrically connected to a voltage source (VDC+). It is to be understood that the voltage source and/or the primary coil 727 may have a current limiting device, such as a current-limiting resistor, in order to limit the amount of current that may flow through the primary coil 727.

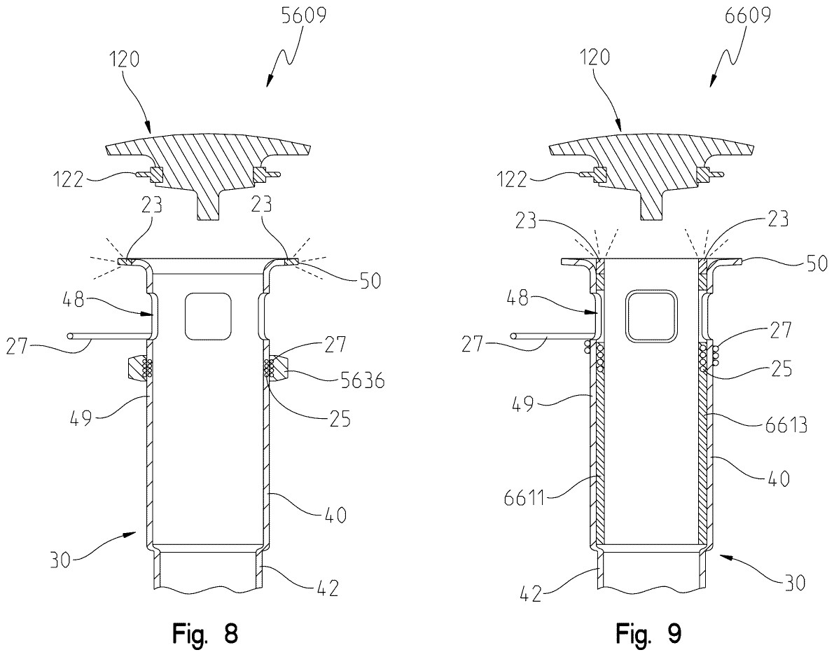

The illustrative inductive pop-up drain nightlight arrangement or device 5609 of FIG. 8 includes many similar components as the inductive pop-up drain nightlight arrangement 9 of FIGS. 1-5. As such, in the following description, similar components are identified with like reference numbers.

In the pop-up drain nightlight arrangement 5609, the light-emitting diodes (LEDs) 23 are illustratively mounted to the flange 50 of the outer pipe 30. Further, the primary coil 27 may be supported on the outside of the outer pipe 30 and hidden in a mounting nut 5636 that cooperates with the outer pipe 30. The secondary coil 25 may be incorporated within the side wall 49 of the outer pipe 30 and operably coupled to the primary coil 27 in a manner similar to that further detailed herein.

The illustrative inductive pop-up drain nightlight arrangement or device 6609 of FIG. 9 includes many similar components as the inductive pop-up drain nightlight arrangement 5609 of FIG. 8. As such, in the following description, similar components are identified with like reference numbers.

In the pop-up drain nightlight arrangement 6609, the light-emitting diodes (LEDs) 23 and the secondary coil 25 are illustratively supported by a cylindrical side wall 6611 of a separate sleeve 6613 that is illustratively received withing the outer pipe 30. Illustratively, the LEDs 23 are supported by the upper end of the sleeve 6613, and the secondary coil 25 is positioned radially inwardly from the outer pipe 30. The primary coil 27 is illustratively supported around the outside of the side wall 49 of the outer pipe 30 and is operably coupled to the secondary coil 25 in a manner similar to that further detailed herein.

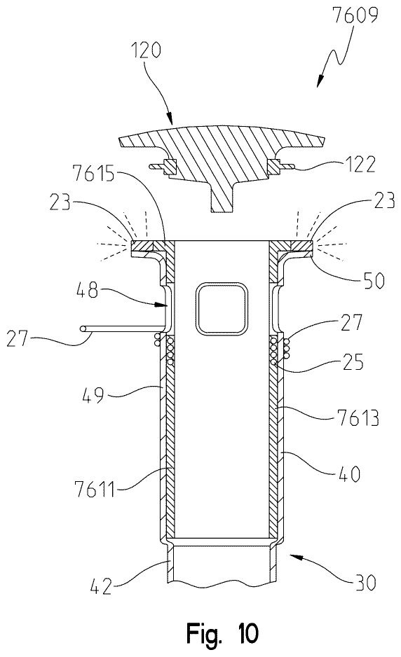

The illustrative inductive pop-up drain nightlight arrangement or device 7609 of FIG. 10 includes many similar components as the inductive pop-up drain nightlight arrangement 5609 of FIG. 8. As such, in the following description, similar components are identified with like reference numbers.

In the pop-up drain nightlight arrangement 7609, the light-emitting diodes (LEDs) 23 and the secondary coil 25 are illustratively supported by a cylindrical side wall 7611 of a separate sleeve 7613 that is received within the outer pipe 30. The sleeve 7613 illustratively includes a flange 7615 that sits atop the flange 50 of the outer pipe 30 and supports LEDs 23 disposed of therein while maintaining the primary coil 27 and secondary coil 25 in a similar configuration to that of FIG. 9. The LEDs 23 are illustratively positioned above the outer pipe 30, and the secondary coil 25 is positioned radially inwardly from the outer pipe 30. The primary coil 27 is illustratively supported around the outside of the outer pipe 30 and is operably coupled to the secondary coil 25 in a manner similar to that further detailed herein.

While the above detailed description is directed to an illumination device in connection with a pop-up drain assembly typically used in a lavatory (bathroom) sink, it should be appreciated that the illumination device may be used with other drain assemblies, including those included in kitchen sinks.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An illuminated drain assembly for a sink basin having a drain opening, the illuminated drain assembly comprising:
a tube having a top end configured to be fluidly coupled to the drain hole of the sink basin;
a drain stopper configured to seal the drain opening of the sink basin;
a light-emitting device mounted to the drain stopper;
a first electrical conductor coiled around an outer surface of the tube, the first electrical conductor having two opposite ends configured to be electrically connected to a voltage source; and
a second electrical conductor coiled around an inner surface of the tube at a location such that an electrical current through the first electrical conductor induces an electrical current through the second electrical conductor, the second electrical conductor having two opposite ends configured to be electrically connected to the light-emitting device.

2. The illuminated drain assembly of claim 1 wherein the light-emitting device is mounted to a top surface of the drain stopper.

3. The illuminated drain assembly of claim 1 wherein the light-emitting device is mounted to a bottom surface of the drain stopper.

4. The illuminated drain assembly of claim 1 wherein the drain stopper is movable between a lower position in which the drain stopper seals the drain opening of the sink basin and an upper position in which the drain stopper does not seal the drain opening of the sink basin.

5. The illuminated drain assembly of claim 1 wherein the tube is electrically nonconductive and non-metallic.

6. The illuminated drain assembly of claim 1 wherein the voltage source is a direct current voltage source.

7. The illuminated drain assembly of claim 1 wherein at least a portion of the first electrical conductor and at least a portion of the second electrical conductor are at a same vertical level.

8. The illuminated drain assembly of claim 1 wherein both the first electrical conductor and the second electrical conductor include a layer of electrical insulation.

9. The illuminated drain assembly of claim 1 wherein at least a portion of the second electrical conductor does not engage the inner surface of the tube.

10. A illuminated drain assembly for a sink basin having a drain opening, the illuminated drain assembly comprising:
a tube having a top end configured to be fluidly coupled to the drain opening of the sink basin, the tube having a through-hole along its length;
a drain stopper configured to seal the drain opening of the sink basin;
a light-emitting device mounted on the drain stopper;
an electrical conductor extending through the through-hole of the tube; and
a grommet supported within the through-hole and receiving the electrical conductor, the electrical conductor having a first end electrically connected to the light-emitting device, and a second end configured to be electrically connected to a voltage source.

11. The illuminated drain assembly of claim 10 wherein the light-emitting device is mounted on a top surface of the drain stopper.

12. The illuminated drain assembly of claim 10 wherein the light-emitting device is mounted on a bottom surface of the drain stopper.

13. The illuminated drain assembly of claim 10 wherein the drain stopper is movable between a lower position in which the drain stopper seals the drain opening of the sink basin and an upper position in which the drain stopper does not seal the drain opening of the sink basin.

14. The illuminated drain assembly of claim 10 wherein the tube is configured for a pop-up drain assembly, and the drain stopper is a push-pop type of drain stopper.

15. The illuminated drain assembly of claim 10 wherein the voltage source is a direct current voltage source.

16. The illuminated drain assembly of claim 10 wherein the electrical conductor includes a layer of electrical insulation.

17. A illuminated drain assembly for a sink basin having a drain opening, the illuminated drain assembly comprising:
a tube having a top end configured to be fluidly coupled to the drain opening of the sink basin;
a light-emitting device associated with the drain opening;
an electrical conductor configured to apply a voltage to the light-emitting diode when the electrical conductor carries an electrical current;
a switch connected in series with the electrical conductor; and
a presence detector configured to:
sense a presence of a human being in a vicinity of the sink basin;
cause the switch to be closed such that the electrical conductor is able to carry electrical current when the presence of the human being in the vicinity of the sink basin is sensed; and
cause the switch to be open such that the electrical conductor is unable to carry electrical current when the presence of the human being in the vicinity of the sink basin is not sensed.

18. The illuminated drain assembly of claim 17 further comprising a drain stopper configured to seal the drain opening of the sink basin, wherein the light-emitting device is associated with the drain stopper.

19. The illuminated drain assembly of claim 18 wherein the light-emitting device is mounted to a top surface of the drain stopper.

20. The illuminated drain assembly of claim 18 wherein the light-emitting device is mounted to a bottom surface of the drain stopper 21.

21. The illuminated drain assembly of claim 18 wherein the drain stopper is movable between a lower position in which the drain stopper seals the drain opening of the sink basin and an upper position in which the drain stopper does not seal the drain opening of the sink basin.

22. The illuminated drain assembly of claim 17 wherein the tube is electrically nonconductive and non-metallic.

23. The illuminated drain assembly of claim 17 wherein the voltage source is a direct current voltage source.

24. The illuminated drain assembly of claim 17 wherein the electrical conductor includes a layer of electrical insulation.

25. The illuminated drain assembly of claim 17 wherein the electrical conductor comprises a first electrical conductor directly electrically connected to a direct voltage source, the lighted drain assembly further comprising a second electrical conductor directly electrically connected to the light-emitting device, the first electrical conductor and the second electrical conductor being configured and positioned such that an electrical current through the first electrical conductor electro-magnetically induces an electrical current through the second electrical conductor.

26. The illuminated drain assembly of claim 17 wherein the electrical conductor comprises a second electrical conductor directly electrically connected to the light-emitting device, the lighted drain assembly further comprising a first electrical conductor directly electrically connected to a direct voltage source, the first electrical conductor and the second electrical conductor being configured and positioned such that an electrical current through the first electrical conductor electro-magnetically induces an electrical current through the second electrical conductor.
